(19) United States
(12) Patent Application Publication
(10) Pub. No.: US 2010/0329241 A1
(43) Pub. Date: Dec. 30, 2010

(54) APPARATUS AND METHOD FOR PREVENTING SPAMS IN VOIP SYSTEM

(75) Inventors: Jeacheol Ryou, Daejeon (KR); Youngchan Shin, Daejeon (KR); Kyuyoung Kim, Daejeon (KR); Minyoung Kim, Daejeon (KR)

Correspondence Address: Edwards Angell Palmer & Dodge LLP, P.O. Box 55874, Boston, MA, 02205, US

(73) Assignee: THE INDUSTRY & ACADEMIC COOPERATION IN CHUNGNAM NA, DAEJEON (KR)

(21) Appl. No.: 12/666,902

(22) PCT Filed: Jun. 27, 2009
(86) PCT No.: PCT/KR08/03720

§ 371 Date: Dec. 28, 2009

(30) Foreign Application Priority Data
Jun. 29, 2007 (KR) 10-2007-0065637

(51) Int. Cl. H04L 12/66

(52) U.S. Cl. 370/352

(57) ABSTRACT

A system for preventing a spam-call for a VoIP system includes a communication network, a plurality of terminals connected via the network, and a server. The server includes a server black list DB, a connection control module, a membership information management module, and a server-side management module. Each of the terminals includes a terminal-side management module. With the system, VoIP spam can be prevented in a cost-effective way and users' convenience can be increased.

### CROSS-REFERENCE TO RELATED APPLICATION

This application is a continuation of PCT/KR2008/003720 filed on Jun. 27, 2008, which claims the benefit of Korean Application No. 10-2007-0065637 filed Jun. 29, 2007, the entire contents of which are incorporated herein by reference.

### TECHNICAL FIELD

The present disclosure relates to a system and method for preventing voice over IP (hereinafter referred to as ‘VoIP’) spam calls (hereinafter referred to as ‘spam’).

### BACKGROUND ART

As Internet communication technology advances rapidly, the number of Internet network-based telephone users have increased. VoIP spam proliferating unwanted and unilateral information has also increased, which becomes a serious issue. Various methods for preventing VoIP spam have been proposed as follows.

(A) Contents filtering method: This method, a general type of a spam prevention method used in e-mail spam, filters spam information by checking contents. However, in case of VoIP, contents cannot be determined until a VoIP user or a VoIP service provider answers a call. Further, In case of contents comprising voice and video, there is a difficulty in determining whether the contents are spam or not because the voice and video recognition technology is not elaborate so far.

(B) Blacklist-based method: This method prevents spam through address mapping by registering spammers to form a blacklist thereof. However, this method may not properly handle the situation where registered spammers are normal users and may not effectively update a blacklist. Further, this method has a disadvantage in that it does not reflect the characteristic of VoIP users since the management of a blacklist is concentrically maintained by a server.

(C) Whitelist-based method: This method is an opposite method to the blacklist-based method and receives only incoming calls from valid users. However, in this method, if a sender is not registered with a whitelist (e.g., when the sender first communicates with a VoIP user), it cannot communicate with the user.

(D) Consent-based communication method: In this method, a user A who wants to communicate with a user B must obtain the user B′s consent. The user B who has given its consent to the user A may be able to accept or reject the user A's subsequent request for consent. This method, however, cannot prevent a consent request from bothering users.

(E) Reputation system-based method: This method helps to block spammers based on the degree of reputation. For example, when a user presses a particular button on a telephone unit in a predetermined way, the sender's id is transmitted to a central reputation system to be registered. Ids that have been reported in a preset number are determined as spammers and will be blocked. In this method, however, innocent users can be registered as spammers through conspiracy.

There is thus a need for technology to prevent VoIP spam in a cost-effective way while increasing users' convenience.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

In one aspect, the present invention provides a system for preventing VoIP spam. The system according to an embodiment includes a communication network, a plurality of terminals including at least one receiving terminal and at least one sending terminal which are connected via the communication network, and a server.

The server may include a server blacklist DB, a connection control module, a membership information management module, and a server-side management module.

The server blacklist DB may store numbers of sending terminals that have been reported as spam by at least one receiving terminal. The connection control module may, in response to a signal of request for call connection from a sending terminal, transfer the call connection request signal to a receiving terminal when the number of the sending terminal does not exist in the server blacklist DB while rejecting the call connection request signal when the sending terminal number exists in the server blacklist DB. The membership information management module may store/manage membership information including the numbers and IPs of the terminals. The server-side management module may store/manage only sending terminal numbers that have been reported as spam by at least one receiving terminal, or store/manage sending terminal numbers and spam report time points in the server blacklist DB.

Each of the receiving terminals may include a terminal-side management module for receiving a spam report signal input by the user of each of the receiving terminals, and transferring the spam report signal to the server-side management module.

In another aspect, the present invention provides a method for preventing VoIP spam using the above-described system. The method according to an embodiment may include the steps of: (a) allowing the server to receive a signal of request for call connection from a sending terminal; (b) transferring the call connection request signal to the receiving terminal when the sending terminal number does not exist in the server blacklist DB while rejecting the call connection request signal when the sending terminal number exists in the server blacklist DB; and (c) storing only the sending terminal number or both the sending terminal number and the spam report time point in the server blacklist DB when the spam report signal is received from the receiving terminal.

In accordance with the present invention, it is possible to cope with VoIP spam through participation of VoIP users. Accordingly, expenses for preventing VoIP spam can be reduced significantly. Further, in accordance with the present invention, transfer of sound/video pre-recorded information that is clearly found as spam can be blocked. Accordingly, the load of an overall VoIP system can be decreased and users' convenience can be increased.

It is understood that the term ‘terminal’ refers to any type of a VoIP device. For example, it may be a stand-alone type telephone unit, a computer in which a program for VoIP is executed and which is equipped with the headset, and so on. It is also understood that the term server' refers to any type of server that can be used for preventing VoIP spam. The server can be realized in may ways. For example, the server may be a physically independent server and may also be a part of the function of a typical operating server for the VoIP.

The above and other aspects, features, and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic configuration of an system for preventing a spam-call for a VoIP system in accordance with a first embodiment of the present invention;

FIG. 2 is a flowchart illustrating a method for preventing spam-call by the system of FIG. 1;

FIG. 3 is a schematic configuration of a system for preventing a spam-call for a VoIP system in accordance with a second embodiment of the present invention;

FIG. 4 is a flowchart illustrating a method for preventing spam-call by the system of FIG. 3;

FIG. 5 is a schematic configuration of a system for preventing a spam-call for a VoIP system in accordance with a third embodiment of the present invention;

FIG. 6 is a flowchart illustrating a method for preventing spam-call by the system of FIG. 5;

FIG. 7 is a schematic configuration of a system for preventing a spam-call for a VoIP system in accordance with a fourth embodiment of the present invention;

FIG. 8 is a flowchart illustrating a method for preventing spam-call by the system of FIG. 7;

FIG. 9 is a schematic configuration of a system for preventing a spam-call for a VoIP system in accordance with a fifth embodiment of the present invention;

FIG. 10 is a flowchart illustrating a method for preventing spam-call by the system of FIG. 9; and

FIG. 11 is a flowchart illustrating another method for preventing spam-call by the system of FIG. 9.

Reference numerals set forth in the Drawings includes reference to the following elements as further discussed below:

110: receiving terminal

111: call control module

112: terminal blacklist DB

113: terminal whitelist DB

114: terminal-side management module

115: membership information management module

116: membership information DB

120: server

121: connection control module

122: pre-filtering module

123: server blacklist DB

124: server whitelist DB

125: server-side management module

### DETAILED DESCRIPTION OF THE DISCLOSURE

Reference will now be made in detail to the embodiments of the present invention, examples of which are illustrated in the drawings attached hereinafter, wherein like reference numerals refer to like elements throughout. The embodiments are described below so as to explain the present invention by referring to the figures.

### (1A) System According to a First Embodiment

A spam-call prevention system in accordance with the present invention includes a communication network, a plurality of terminals connected via the network, and a server.

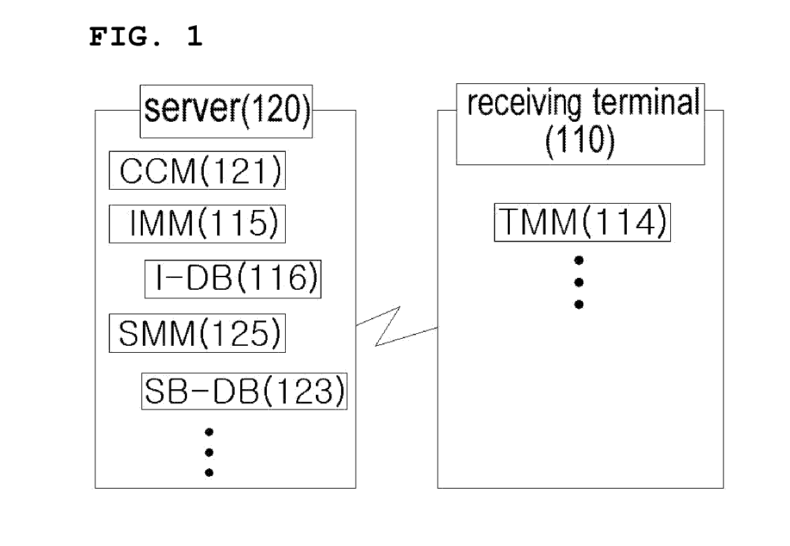

In an embodiment, as shown in FIG. 1, the server 120 includes a connection control module (CCM) 121, a server blacklist DB (SB-DB) 123, a membership information management module (IMM) 115, and a server-side management module (SMM) 125.

The server blacklist DB 123 may store sending terminal numbers that have been reported as spam by at least one receiving terminal 110.

The connection control module 121 may, when there is a signal of request for call connection from a sending terminal, transfer the call connection request signal to a receiving terminal 110 when the sending terminal number does not exist in the server blacklist DB 123. It, on the other hand, may reject the call connection request signal when the sending terminal number exists in the server blacklist DB.

The membership information management module 115 may store/manage membership information that includes the numbers and IPs of the terminals. The server 120 may include a membership information DB (I-DB) 116 for storing the membership information.

The server-side management module 125 may store/manage sending terminal numbers that have been reported as spam by at least one receiving terminal 110, and store/manage information about the sending terminal numbers and/or spam report time points in the server blacklist DB 123.

Meanwhile, each of the terminals 110 includes a terminal-side management module (TMM) 114 for receiving a spam report signal and transfers the spam report signal to the server-side management module.

In more detail, when there is a call connection request signal from a sending terminal to a receiving terminal, the connection control module 121 first searches the server blacklist DB 123 in order to check whether the sending terminal number exists in the server blacklist DB 123. If, as a result of the search, the sending terminal number does not exist in the server blacklist DB 123, the connection control module 121 transfers the call connection request signal to the receiving terminal 110. If, on the other hand, the sending terminal number exists in the server blacklist DB 123, the connection control module 121 denies the call connection request.

The server-side management module 125 may manage the server blacklist DB 123. That is, the server-side management module 125 stores/manages sending terminal numbers that have been reported as spam by at least one receiving terminal 110. Preferably, it stores/manages sending terminal numbers and/or spam report time points in the server blacklist DB 123.

The server blacklist DB 123 may store sending terminal numbers that have been reported as spam by at least one receiving terminal 110. It is to be understood that the sending terminal numbers may suitably be automatically input to a blacklist stored in the server blacklist DB 123, and evident spam may suitably be manually input to the blacklist by an administrator.

Meanwhile, a sending terminal number that has been reported as spam can be subsequently treated as non-spam. In order to facilitate the treatment, in the case in which a sending terminal number is reported as spam by any receiving terminal 110, not only the sending terminal number but also information about the time point when the spam was reported may be stored in the server blacklist DB 123, and the sending terminal number may automatically be deleted from the server blacklist DB 123 if a call connection request has not been made from the sending terminal number for a predetermined period of time.

The terminal-side management module 114 may receive the spam report signal and transfer the spam report signal to the server-side management module 125. More particularly, when the number of a sending terminal that has requested call connection to the receiving terminal 110 through the server 120 does not exist in the server blacklist DB 123, the call connection request signal is transferred to the receiving terminal 110. In the case in which a user of the receiving terminal 110 who has received the call confirms that the sending terminal number is a spam number and reports the spam number via, for example, a method of pressing a spam report button after finishing a call, the terminal-side management module 114 transfers the signal to the server-side management module 125 so that the sending terminal number is stored in the server blacklist DB 123. Preferably, when transferring the spam report signal, the terminal-side management module 114 may transfer the spam report signal to the server 120 along with the sending terminal number. However, in the case in which information of the sending terminal number is stored (temporarily) in the server 120, suitably, it may transfer only the spam report signal.

### (1B) Method According to a First Embodiment

The present invention provides a method of preventing VoIP spam using the above-described system (1A). In an embodiment of the present invention, the method may include the steps of (a) allowing the server 120 to receive a signal of request for call connection from a sending terminal; (b) transferring the call connection request signal to the receiving terminal 110 when the sending terminal number does not exist in the server blacklist DB 123 while rejecting the call connection request signal when the sending terminal number exists in the server blacklist DB 123; and (c) after a spam report signal is received from the receiving terminal 110, storing the sending terminal number in the server blacklist DB 123.

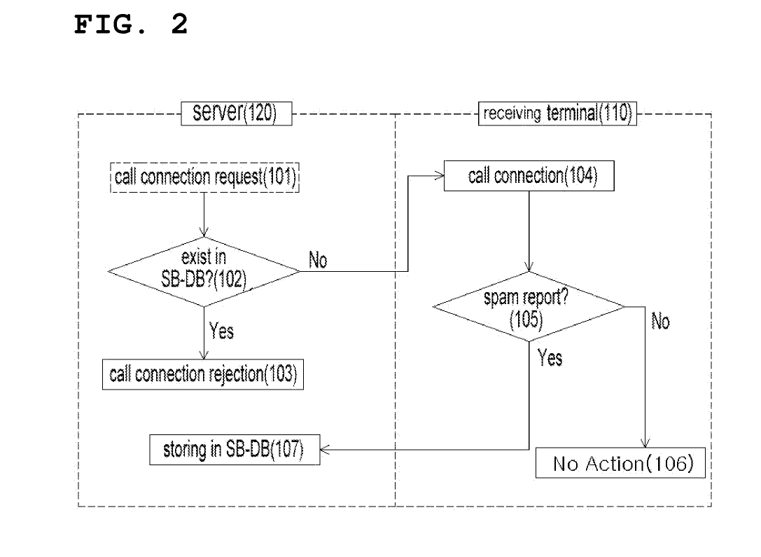

The method is described in detail with reference to FIG. 2. In step 101, the server 120 receives a call (communication) connection request signal from a sending terminal. In step 102, the server 120 searches the SB-DB in order to determine whether to accept the call connection request. If, as a result of the search, the number of the sending terminal exists in the SB-DB, the server 120 rejects the call connection request (step 103). If, on the other hand, the number of the sending terminal does not exist in the SB-DB, the server 120 transfers the call connection request signal to the receiving terminal 110.

The user of the receiving terminal 110, after the call connection occurs (preferably, after the call is answered and finished) (step 104), may report the sending terminal number as spam. The spam report can be made in various ways. As an example, the user can push a button provided in the receiving terminal for spam report. The receiving terminal 110 determines whether there is a spam report (step 105). If it is determined that there is a spam report, the receiving terminal 110 transfers the spam report signal to the server 120 so that the sending terminal number is stored in the SB-DB (step 107). If, on the other hand, it is determined that there is no spam report, the receiving terminal 110 takes no action (step 106).

Preferably, information about the time point when a spam report was received may be stored in the server blacklist DB 123 as well as the sending terminal number such that the sending terminal number can be deleted from the server blacklist DB 123 where a call connection request has not been made for a predetermined period of time.

On the other hand, the information about the sending terminal number that is call connected to the specific receiving terminal 110 can be stored in the server 120. A detailed spam report signal may comprise a ‘spam telephone number and information, indicating that the spam telephone number is spam’ or may comprise simply ‘information indicating that a recently call-connected sending terminal number is spam.’

### (2A) System According to a Second Embodiment

In some cases, a sending terminal number can be mistakenly or erroneously reported as spam or a user (called party) of a receiving terminal may want to change the record of a sending terminal number that has been reported as spam to non-spam.

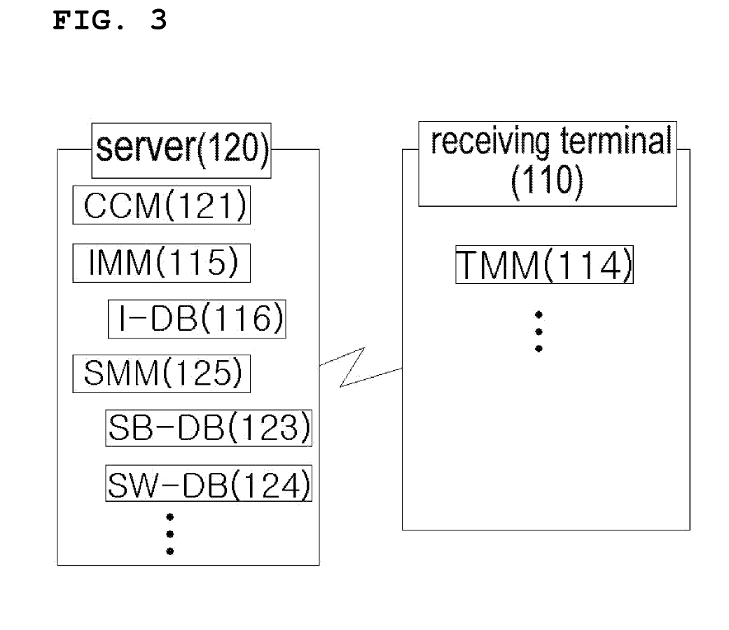

To this end, a system according to a second embodiment of the present invention is provided. As shown in FIG. 3, the system of the second embodiment includes additional constituent(s) and resulting function(s) compared to the system of the first embodiment. The features different from the first embodiment will be described while the same features as those of the first embodiment are omitted.

In particular, the server 120 further includes a server whitelist DB (SW-DB) 124. The SW-DB may store evident non-spam sending terminal numbers. Preferably, the evident non-spam sending terminal numbers may be manually confirmed by a user/operator. The server-side management module 125 further includes a function of disregarding a spam report for a sending terminal number when the sending terminal number exists in the SW-DB 124.

### (2B) Method According to a Second Embodiment

The present invention provides a method of preventing VoIP spam using the above-described system (2A). In an embodiment of the present invention, the method may include the steps of (a) allowing the server 120 to receive a call connection request signal from a sending terminal; (b) transferring the call connection request signal to the receiving terminal 110 when the sending terminal number exists only in the server whitelist DB 124 or both in the server whitelist DB 124 and in the server blacklist DB 123 while rejecting the call connection request signal when the sending terminal number exists in the server blacklist DB 123; (c) in the case in which a spam report signal is received from the receiving terminal 110, disregarding the spam report when the sending terminal number exists in the server whitelist DB 124 while storing the sending terminal number, or both the sending terminal number and a spam report time in the server blacklist DB 123 when the sending terminal number does not exist in the server whitelist DB 124.

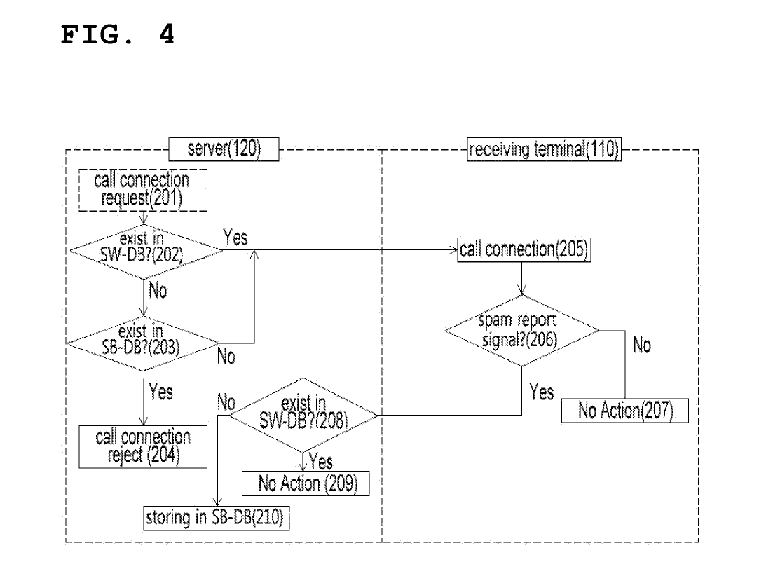

The method is described in detail with reference to FIG. 4. First, in step 201, the server 120 receives a call (communication) connection request signal from a sending terminal. Next, the server 120 searches the SW-DB in order to determine whether to accept the call connection request (step 202). If, as a result of the search, the number of the sending terminal exists in the SW-DB, the server 120 transfers the call connection signal to the receiving terminal 110. If, on the other hand, the number of the sending terminal does not exist in the SW-DB, the server 120 then determines whether the sending terminal number exists in the SB-DB (step 203). If, as a result of the determination, the sending terminal number exists in the SB-DB, the server 120 rejects the call connection request (step 204). If, on the other hand, the sending terminal number does not exist in the SB-DB, the server 120 transfers the call connection request signal to the receiving terminal 110.

After the sending terminal is call connected to the receiving terminal 110 (step 205), the receiving terminal 110 determines whether there is a spam report signal from a called party, as described above (step 206). If, as a result of the determination, there is a spam report signal, the receiving terminal 110 transfers the spam report signal to the server 120. If, on the other hand, there is no such spam report signal, the receiving terminal 110 takes no action (step 207).

The SMM of the server 120, after receiving the spam report signal, determines whether the sending terminal number reported as spam exists in the SB-DB (step 208). If, as a result of the determination, the number exists in the SB-DB, the SMM takes no action (step 209). If, on the other hand, the number does not exist in the SB-DB, the SMM stores the number in SB-DB (step 210).

### (3A) System According to a Third Embodiment

In some cases, a sending terminal number that is generally non-spam still can be spam with respect to only a particular receiving terminal (user) or a particular group of terminals (users), in which a call may not be connected to the other receiving terminals or the other groups of receiving terminals.

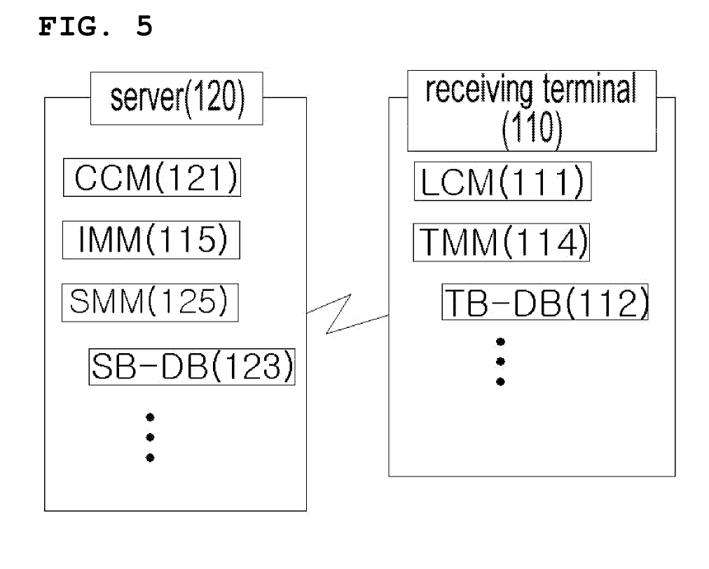

To this end, a system according to a third embodiment of the present invention is provided. As shown in FIG. 5, the system of the third embodiment includes additional constituent(s) and resulting function(s) compared to the system of the first embodiment. The features different from the first embodiment will be described while the same features as those of the first embodiment are omitted.

More specifically, the receiving terminal 110 further includes a call control module (LCM) 111 and a terminal blacklist DB (TB-DB) 112 for storing/managing spam sending terminal numbers.

In response to a call connection request signal received from the connection control module 121, the call control module 111 may generate a called signal such as ring tome or vibration if the sending terminal number does not exist in a terminal blacklist DB (TB-DB) 112 while rejecting the call connection request signal if the sending terminal number exists in the terminal blacklist DB 112. In addition, the call control module 111 may transmit a spam report signal to the terminal-side management module 114 if the spam report signal is received from a user after call connection occurs.

The terminal-side management module 114 further includes a function of storing a sending terminal number in the terminal blacklist DB 112 when a spam report signal is received after a call from the call control module 111.

Preferably, the terminal blacklist DB 112 may be disposed in the receiving terminal 110. Also preferably, the call control module 111 may be disposed in the receiving terminal 110.

### (3B) Method According to a Third Embodiment

The present invention provides a method of preventing VoIP spam using the above-described system (3A). In an embodiment of the present invention, the method may include the steps of: (a) allowing the server to receive a call connection request signal from a sending terminal; (b) transferring the call connection request signal to the receiving terminal when the sending terminal number does not exist in the server blacklist DB while rejecting the call connection request signal when the sending terminal number exists in the server blacklist DB; (c) transferring a call connection request signal from the connection control module to the receiving terminal when the sending terminal number does not exist in the terminal blacklist DB while rejecting the call connection request signal when the sending terminal number exists in the terminal blacklist DB; (d) when the spam report signal is received from a user after call connection occurs, transferring a spam report signal to terminal management module and storing the sending terminal number in terminal blacklist DB; and (e) storing only the sending terminal number or both the sending terminal number and the spam report time in the server blacklist DB when a spam report signal is received from the receiving terminal.

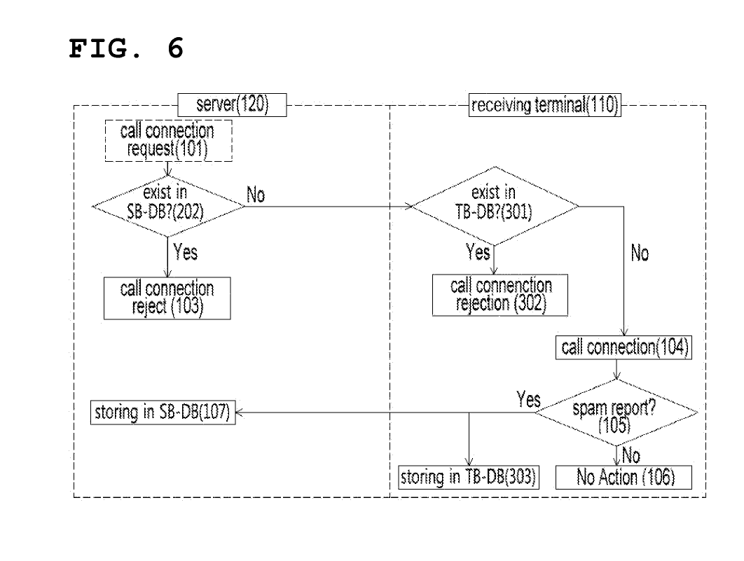

That is, as shown FIG. 6, the method further includes a step 301 of searching the TB-DB between the steps 102 and 104 of the method (1B) and a step 303 of storing a spam number in the TB-DB between the steps 105 and 107 of the method (1B).

In more detail, when a call connection request signal is received from the connection control module 121, the TB-DB is searched for a sending terminal number (step 301). If, as a result of the search, the sending terminal number does not exist in the terminal blacklist DB 112, a called signal, such as a ring tone or vibration, is generated so that a user can answer the call (step 104). If, on the other hand, the sending terminal number exists in the terminal blacklist DB 112, the call connection request is rejected (step 302).

Further, when it is determined that a spam report signal is received (step 105), the spam report signal is transmitted to the terminal-side management module 114 and a sending terminal number is stored in the TB-DB (step 303).

The description of the remaining steps is omitted since they are identical to those of the method (1B).

### (4A) System According to a Fourth Embodiment

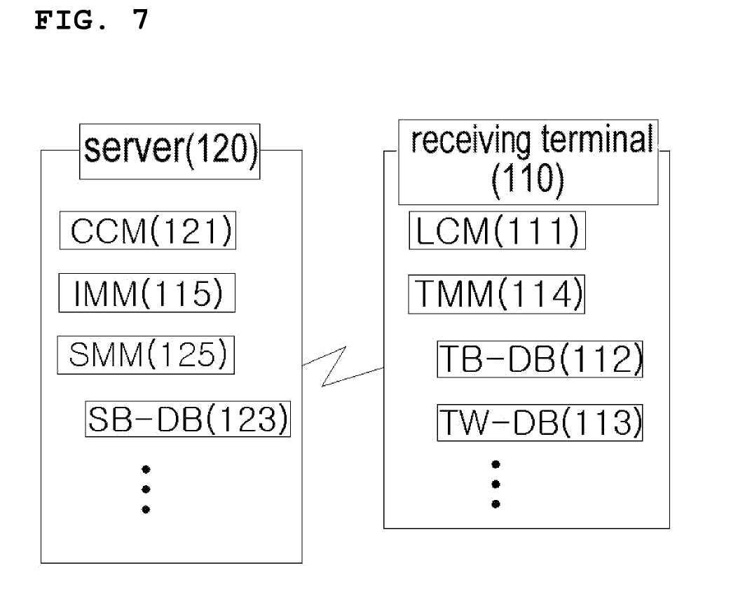

In some cases, the user of a receiving terminal may want to handle/manage the records of sending terminal numbers. For this purpose, a system according to a fourth embodiment of the present invention is provided. As shown in FIG. 7, the system of the fourth embodiment includes additional constituent(s) and resulting function(s) compared to the system of the third embodiment. The features different from the first embodiment will be described while the same features as those of the third embodiment are omitted.

That is, the terminal of the present system further includes a terminal whitelist DB (TW-DB) 113. The TW-DB 113 may store non-spam sending terminal numbers, for example, a ‘personal telephone directory’ manually input to a terminal by a user.

The call control module 111 further includes a function of, in response to a call connection request signal received from the connection control module 121, generating a called signal when the sending terminal number exists in the terminal whitelist DB 113 or does not exist in the terminal blacklist DB 112 while rejecting the call connection request signal when the sending terminal number exists in the blacklist DB.

In addition, the terminal-side management module 114 further includes a function of storing a sending terminal number in the terminal whitelist DB 113 when a spam report signal is not received after call connection.

### (4B) Method According to a Fourth Embodiment

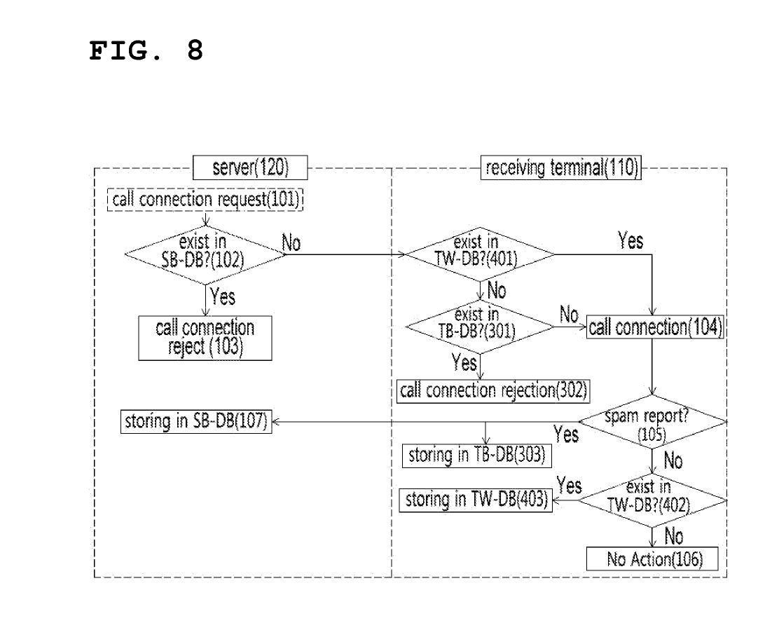

The present invention provides a method of preventing VoIP spam using the above-described system (4A). As shown in FIG. 8, the method further includes a step 401 of searching the TW-DB between the steps 102 and 301 of the method (3B) and step 402 of managing the TW-DB.

As shown, when a call connection request signal is received from the connection control module 121, the terminal whitelist DB 113 is searched in order to determine whether a sending terminal number exists in the terminal whitelist DB 113 (step 401). If, as a result of the search, the sending terminal number exists in the terminal whitelist DB 113, a call connection is established (i.e., a called signal is generated) (step 104). If, on the other hand, the sending terminal number does not exist in the TW-DB 113, the process proceeds to the step 301 of searching the terminal blacklist DB 112.

Before or after a spam report signal is checked (step 105) (although the latter case is illustrated in the drawing), a step 402 of querying a user of the receiving terminal 110 as to whether a sending terminal number will be stored in the terminal whitelist DB 113 (this can be a personal telephone directory), a step 403 of, when a signal indicating that the sending terminal number will be stored in the terminal whitelist DB 113 is received, storing the sending terminal number in the terminal whitelist DB 113, and a step 106 of, when the stored signal is not input, taking no action are performed separately.

Meanwhile, if a spam report signal is not received after call connection occurs, the sending terminal number may be automatically stored in the terminal whitelist DB 113 (not shown).

Although not shown, a user may directly manage the TW-DB through a terminal key entry.

The description of the remaining steps is omitted since they are identical to those of the method (3B).

### (5A) System According to a Fifth Embodiment

Typically, a spam call, like a spam email, is transmitted massively and randomly. Transmitted information is generally unidirectional information that is voice- or video-recorded in advance. Accordingly, it is preferred to treat information, which is received from a sending terminal that makes a call connection request for the first time or at specific time intervals, as spam by checking whether the information is unidirectional information.

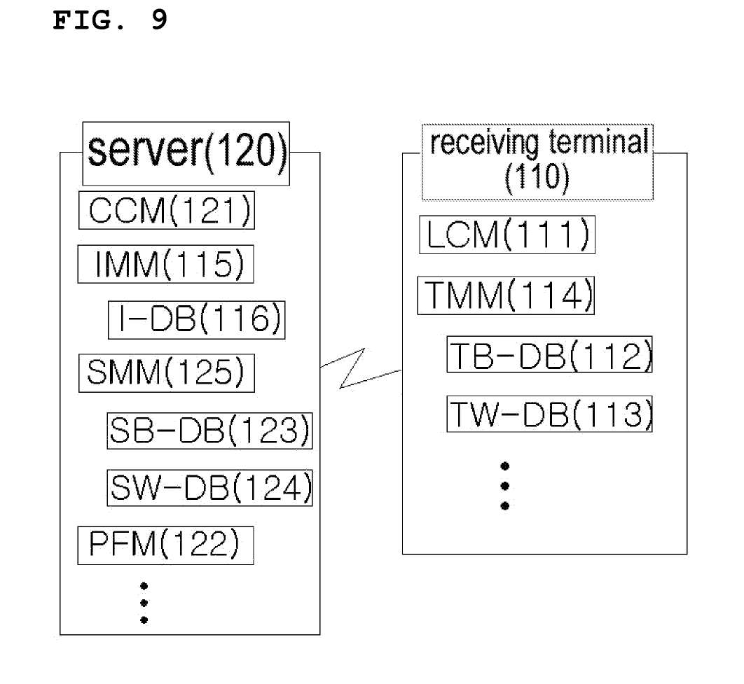

To this end, a system according to a fifth embodiment of the present invention is provided. As shown in FIG. 9, the system of the fourth embodiment includes additional constituent(s) and resulting function(s) compared to the systems of the first to third embodiments. The features different from the first embodiment will be described while the same features as those of the first to third embodiments are omitted.

That is, the server 120 of the present system further includes a pre-filtering module (PFM) 122 as well as a server whitelist DB 124.

The server whitelist DB 124 may store sending terminal numbers that are evidently or likely non-spam or sending terminal numbers that have been connected to the receiving terminal 110 but have not been reported as spam.

The pre-filtering module 122 is operated when the sending terminal number does not exist in both the server blacklist DB 123 and the server whitelist DB 124. It may generate a question based on voice or video information which can be recognized by a person in order to check whether a mechanical device operates the sending terminal to transmit such information, and request an answer from a sending terminal by sending the question to the sending terminal. When a correct answer is returned from the sending terminal, the sending terminal number is determined as non-spam. On the other hand, when the answer is not returned or when an incorrect answer is returned from the sending terminal, the sending terminal number is determined as spam and the sending terminal number is transmitted to the server-side management module 125.

Preferably, the pre-filtering module 122 may add various voice, video and/or noise in order to prevent the sending terminal from mechanically recognizing the question.

The connection control module 121 further includes a function of operating the pre-filtering module 122 when the sending terminal number exists in both the server blacklist DB 123 and the server whitelist DB 124.

The server-side management module 125 further includes a function of storing a sending terminal number in the server whitelist DB 124 or the server blacklist DB 123 based on information received from the pre-filtering module 122.

Meanwhile, in order to prevent evident non-spam sending terminals from being stored in the SB-DB, the server-side management module 125 may preferably further include a function of disregarding a spam report when a sending terminal number that has been reported as spam by any receiving terminal 110 exists in the server whitelist DB 124.

### (5B) Method According to a Fifth Embodiment

The present invention provides a method of preventing VoIP spam using the above-described system (5A). In an embodiment of the present invention, the method may include the steps of (a) allowing the server 120 to receive a call connection request signal from a sending terminal; (b) allowing the server 120 to reject the call connection request signal when the sending terminal number exists in the server blacklist DB 123 while transmitting the call connection request signal to the receiving terminal 110 when the sending terminal number does not exist in the server blacklist DB 123 but exists in the server whitelist DB 124; and (c) when a spam report signal is received from the receiving terminal 110, allowing the server 120 to store the sending terminal number or both the sending terminal number and spam report time point in the server blacklist DB 123.

That is, the method may further include generating a question based on voice or video information and requesting an answer from the sending terminal by forwarding the question to the sending terminal, when the sending terminal number does not exist in the server blacklist DB nor in the server whitelist DB, and storing the sending terminal number in the server whitelist DB 124, and transferring the call connection request signal to the receiving terminal 110 when a correct answer is returned from the sending terminal while storing the sending terminal number in the server blacklist DB 123, and rejecting the call connection request when the answer is not returned from the sending terminal or an incorrect answer is returned from the sending terminal

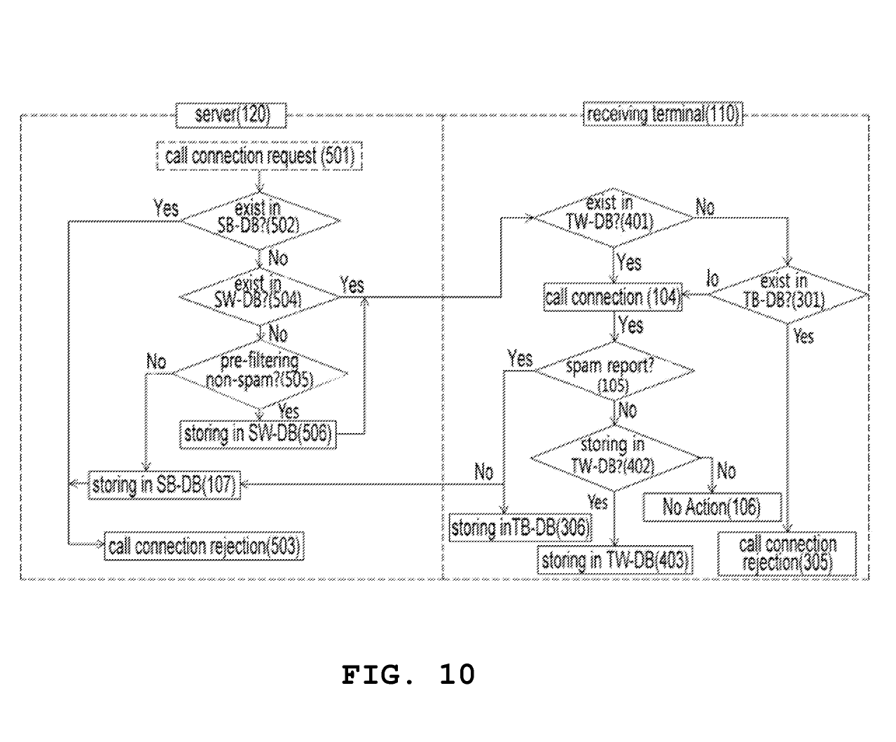

The method is described in detail with reference to FIG. 10. First, in step 501, the server 120 receives a call (communication) connection request signal from a sending terminal. The server 120 searches the SB-DB in order to determine whether to reject the call connection request signal (step 502). If, as a result of the search, the sending terminal number exists in the SB-DB, the server 120 rejects the call connection request (step 503). If, on the other hand, the sending terminal number does not exist in the SB-DB, the server 120 proceeds to a step 504 of searching the SW-DB. If, as a result of the search for the SW-DB in step 504, the sending terminal number exists in the SW-DB, the server 120 transmits the call connection request signal to the receiving terminal 110. If, on the other hand, the number of the sending terminal does not exist in the SW-DB, the server 120 proceeds to a step 505.

The step 505 is a pre-filtering step in which a question is generated as voice or video, an answer is requested from the sending terminal by sending the generated question to the sending terminal, and whether a correct answer is returned from the sending terminal is determined or whether the answer is not returned from the sending terminal or an incorrect answer is returned from the sending terminal is determined. When the correct answer is returned from the sending terminal, the server 120 stores the sending terminal number in the server whitelist DB 124 (step 506) and transmits the call connection request signal to the receiving terminal 110. When the answer is not returned from the sending terminal or an incorrect answer is returned from the sending terminal, the server 120 stores the sending terminal number in the server blacklist DB 123 (step 107) and rejects the call connection request (step 503).

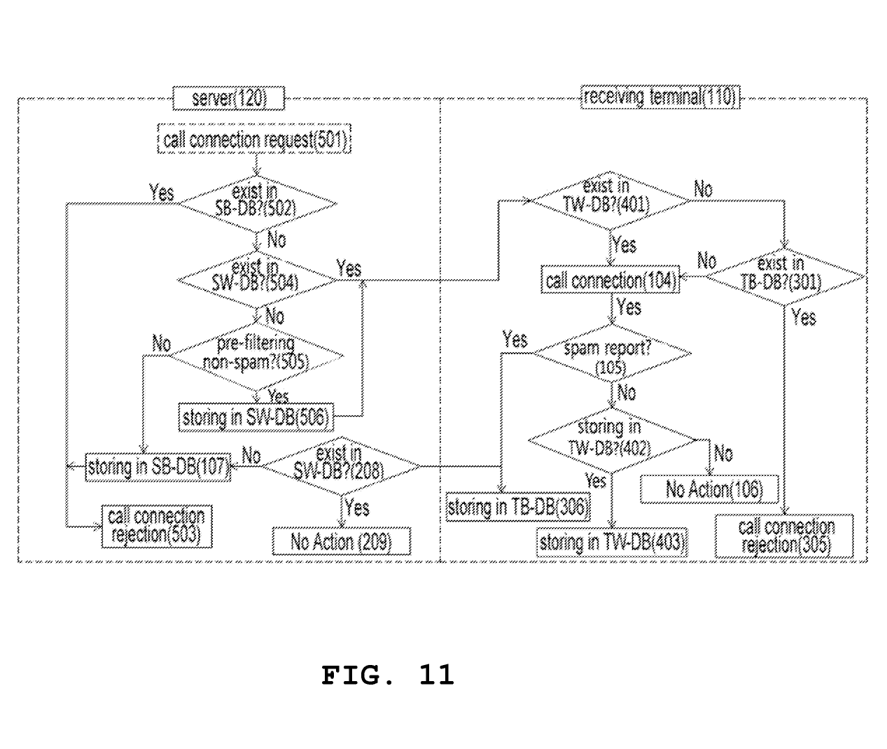

Further detailed description of the steps 504 and 506 is omitted since they are identical to the steps 401 and 301 of the method (4B). Meanwhile, a spam prevention method employing the system having the function of disregarding a spam report is described with regard to FIG. 11.

The spam prevention method is identical to FIG. 10 except that the steps 208, 209 and 210 shown in FIG. 4 are added between the steps 105 and 107 of FIG. 10. That is, the SMM of the server 120 that has received a spam report signal determines whether the sending terminal number reported as spam exists in the SB-DB (step 208), does not take no action when it is determined that the sending terminal number exists in the SB-DB (step 209) while storing the sending terminal number in the SB-DB when it is determined that the sending terminal number does not exist in the SB-DB (step 107).

In accordance with the present invention, VoIP spam can be prevented in a cost-effective way, the load of an overall VoIP system can be reduced, and user convenience can be increased.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A system for preventing VoIP spam call, the system including: a communication network, a plurality of terminals including at least one receiving terminal and at least one sending terminal which are connected via the network, and a server,
wherein the server includes:
(1) a server blacklist DB for storing numbers of sending terminals that have been reported as spam by at least one receiving terminal;
(2) a connection control module for, in response to a signal of request for call connection from a sending terminal, transferring the call connection request signal to a receiving terminal when the number of the sending terminal does not exist in the server blacklist DB, and rejecting the call connection request signal when the sending terminal number exists in the server blacklist DB;
(3) a membership information management module for storing/managing membership information including the numbers and IPs of the terminals; and
(4) a server-side management module for storing/managing sending terminal numbers that have been reported as spam by at least one receiving terminal, or storing/managing sending terminal numbers and spam report time points in the server blacklist DB, and
wherein each of the receiving terminals includes a terminal-side management module for receiving a spam report signal input by the user of each of the receiving terminals, and transferring the spam report signal to the server-side management module.

2. The system according to claim 1,
wherein the server further includes a server whitelist DB for storing non-spam sending terminal numbers, and
wherein the server-side management module further includes a function of disregarding the spam report when the sending terminal number, although having been reported as spam by at least one receiving terminal, exists in the server whitelist DB.

3. The system according to claim 1,
wherein each of the receiving terminals further includes:
(1) a terminal blacklist DB for storing spam sending terminal numbers; and
(2) a call control module which, in response to a call connection request signal received from the connection control module, generates a called signal when the sending terminal number does not exist in the terminal blacklist DB while rejecting the call connection request signal when the sending terminal number exists in the terminal blacklist DB, and, in response to the spam report signal received from the user, transmits the spam report signal to the terminal-side management module, and
wherein the terminal-side management module further includes a function of storing the sending terminal number in the terminal blacklist DB when the spam report signal is received.

4. The system according to claim 3,
wherein each of the receiving terminals further includes a terminal whitelist DB for storing non-spam sending terminal numbers,
wherein the call control module further includes a function of, in response to a call connection request signal received from the connection control module, generating a called signal when the sending terminal number exists in the terminal whitelist DB or does not exist the terminal blacklist DB while rejecting the call connection request signal when the sending terminal number exists in the terminal blacklist DB, and
wherein the terminal-side management module further includes a function of storing the sending terminal number in the terminal whitelist DB when the spam report signal is not received after call connection occurs.

5. The system according to claim 1,
wherein the server further includes:
(1) a server whitelist DB for storing sending terminal numbers that are evidently non-spam or have not been reported as spam; and
(2) a pre-filtering module for (a) generating a question based on voice or video information and requesting an answer from the sending terminal by forwarding the question to the sending terminal, (b) determining that the sending terminal number as non-spam when a correct answer is returned while determining that the sending terminal number as spam when the answer is not returned or when an incorrect answer is returned, and (c) transmitting the determination result to the server-side management module,
wherein the connection control module further includes a function of operating the pre-filtering module when the sending terminal number exists in both the server blacklist DB and the server whitelist DB, and
wherein the server-side management module further includes a function of storing the sending terminal number in the server whitelist DB or the server blacklist DB based on determination result received from the pre-filtering module.

6. The system according to claim 5, wherein the server-side management module preferably further includes a function of disregarding the spam report when the sending terminal number exists in the server whitelist DB.

7. The system according to claim 3,
wherein the server further includes:
(1) a server whitelist DB for storing sending terminal numbers that are evidently non-spam or have not been reported as spam; and
(2) a pre-filtering module for (a) generating a question based on voice or video information and requesting an answer from the sending terminal by forwarding the question to the sending terminal, (b) determining that the sending terminal number as non-spam when a correct answer is returned while determining that the sending terminal number as spam when the answer is not returned or when an incorrect answer is returned, and (c) transmitting the determination result to the server-side management module,
wherein the connection control module further includes a function of operating the pre-filtering module when the sending terminal number exists in both the server blacklist DB and the server whitelist DB, and
wherein the server-side management module further includes a function of storing the sending terminal number in the server whitelist DB or the server blacklist DB based on determination result received from the pre-filtering module.

8. The system according to claim 7, wherein the server-side management module preferably further includes a function of disregarding the spam report when the sending terminal number exists in the server whitelist DB.

9. The system according to claim 4,
wherein the server further includes:
(1) a server whitelist DB for storing sending terminal numbers that are evidently non-spam or have not been reported as spam; and
(2) a pre-filtering module for (a) generating a question based on voice or video information and requesting an answer from the sending terminal by forwarding the question to the sending terminal, (b) determining that the sending terminal number as non-spam when a correct answer is returned while determining that the sending terminal number as spam when the answer is not returned or when an incorrect answer is returned, and (c) transmitting the determination result to the server-side management module,
wherein the connection control module further includes a function of operating the pre-filtering module when the sending terminal number exists in both the server blacklist DB and the server whitelist DB, and
wherein the server-side management module further includes a function of storing the sending terminal number in the server whitelist DB or the server blacklist DB based on determination result received from the pre-filtering module.

10. The system according to claim 9, wherein the server-side management module preferably further includes a function of disregarding the spam report when the sending terminal number exists in the server whitelist DB.

11. A method for preventing VoIP spam using the system of claim 1, including the steps of:
(a) allowing the server to receive a signal of request for call connection from a sending terminal;
(b) transferring the call connection request signal to the receiving terminal when the sending terminal number does not exist in the server blacklist DB while rejecting the call connection request signal when the sending terminal number exists in the server blacklist DB; and
(c) storing only the sending terminal number or both the sending terminal number and the spam report time point in the server blacklist DB when the spam report signal is received from the receiving terminal.

12. A method for preventing VoIP spam using the system of claim 2, including the steps of:
(a) allowing the server to receive a signal of request for call connection from a sending terminal;
(b) transferring the call connection request signal to the receiving terminal when the sending terminal number exists only in the server whitelist DB or both in the server whitelist DB and in the server blacklist DB while rejecting the call connection request signal when the sending terminal number exists in the server blacklist DB; and
(c) in the case in which the spam report signal is received from the receiving terminal, disregarding the spam report when the sending terminal number exists in the server whitelist DB while storing only the sending terminal number or both the sending terminal number and the spam report time point in the server blacklist DB when the sending terminal number does not exist in the server whitelist DB.

13. A method for preventing VoIP spam using the system of claim 3, including the steps of:
(a) allowing the server to receive a signal of request for call connection from a sending terminal;
(b) transferring the call connection request signal to the receiving terminal when the sending terminal number does not exist in the server blacklist DB while rejecting the call connection request signal when the sending terminal number exists in the server blacklist DB;
(c) transferring the call connection request signal from the connection control module to the receiving terminal when the sending terminal number does not exist in the terminal blacklist DB while rejecting the call connection request signal when the sending terminal number exists in the terminal blacklist DB;
(d) when a spam report signal is received after call connection occurs, transferring the spam report signal to the terminal management module and storing the sending terminal number to terminal blacklist DB; and
(e) storing only the sending terminal number or both the sending terminal number and the spam report time point in the server blacklist DB when the spam report signal is received from the receiving terminal.

14. A method for preventing VoIP spam using the system of claim 4, including the steps of:
(a) allowing the server to receive a signal of request for call connection from a sending terminal;
(b) transferring the call connection request signal to the receiving terminal when the sending terminal number does not exist in the server blacklist DB while rejecting the call connection request signal when the sending terminal number exists in the server blacklist DB;
(c) transferring the call connection request signal from the connection control module to the receiving terminal when the sending terminal number does not exist in the terminal blacklist DB while rejecting the call connection request signal when the sending terminal number exists in the terminal blacklist DB;
(d) (i) when a spam report signal is received after call connection occurs, transferring the spam report signal to the terminal management module and storing the sending terminal number in the terminal blacklist DB, and (ii) when the spam report signal is not received after call connection occurs, storing the sending terminal number in the terminal whitelist DB; and
(e) storing only the sending terminal number or both the sending terminal number and the spam report time point in the server blacklist DB when the spam report signal is received from the receiving terminal.

15. A method for preventing VoIP spam using the system of claim 5, including the steps of:
(a) allowing the server to receive a signal of request for call connection from a sending terminal;
(b) (i) allowing the server to reject a call connection request-signal when the sending terminal number exists in the server blacklist DB, (ii) transmitting the call connection request signal to the receiving terminal when the sending terminal number does not exist in the server blacklist DB, but exists in the server whitelist DB, and (iii) (iii-a) generating a question based on voice or video information and requesting an answer from a sending terminal by forwarding the question to the sending terminal, when the sending terminal number does not exist in the server blacklist DB nor in the server whitelist DB, and (iii-b) then (iii-b-a) storing the sending terminal number in the server whitelist DB, and transferring a call connection request signal to the receiving terminal when a correct answer is returned from the sending terminal, or (iii-b-b) storing the sending terminal number in the server blacklist DB, and rejecting the call connection-request signal when the answer is not returned from the sending terminal or an incorrect answer is returned from the sending terminal; and
(c) allowing the server to store only the sending terminal number or both the sending terminal number and the spam report time point in the server blacklist DB when the spam report signal is received from the receiving terminal.

16. The method according to claim 15, wherein the step (c), the spam report is disregarded when the sending terminal number exists in the server whithelist DB.
